(19) United States
(12) Patent Application Publication
(10) Pub. No.: US 2002/0149343 A1
(43) Pub. Date: Oct. 17, 2002

(54) Portable telephone charger

(76) Inventor: Mei-Ling Huang, Taichung (TW)

Correspondence Address: Mei-Ling Huang, 58, MA YUAN WEST ST., TAICHUNG, TW

(21) Appl. No.: 09/834,543

(22) Filed: Apr. 15, 2001

(51) Int. Cl. H02J 7/00

(52) U.S. Cl. 320/112

(57) ABSTRACT

A portable telephone charger has a charging seat, a connection wire, a first plug, and a second plug. A transformer is disposed in the charging seat. A cell chamber is formed on the charging seat. A connection socket is formed on the charging seat. A plurality of inner wires are disposed in the charging seat to connect the transformer and the cell chamber. The first plug is inserted in the connection socket. The connection wire is connected to the first plug and the second plug.

### BACKGROUND OF THE INVENTION

The present invention relates to a portable telephone charger. More particularly, the present invention relates to a portable telephone charger without an embedded cell of a portable telephone.

A conventional embedded cell of a portable telephone is often broken or short of electricity. Then the portable telephone will become useless.

### SUMMARY OF THE INVENTION

An object of the present invention is to provide a portable telephone charger which need not use an embedded cell of a portable telephone.

Accordingly, a portable telephone charger is connected to a portable telephone. The portable telephone charger comprises a charging seat, a connection wire, a first plug, and a second plug. A transformer is disposed in the charging seat. A cell chamber is formed on the charging seat. A connection socket is formed on the charging seat. A plurality of inner wires are disposed in the charging seat to connect the transformer and the cell chamber. The first plug is inserted in the connection socket. The connection wire is connected to the first plug and the second plug.

### BRIEF DESCRIPTION OF THE DRAWINGS

FIG. 1 is a perspective exploded view of a portable telephone charger of a preferred embodiment in accordance with the present invention; and

FIG. 2 is a sectional assembly view of a portable telephone charger of a preferred embodiment in accordance with the present invention.

### DETAILED DESCRIPTION OF THE INVENTION

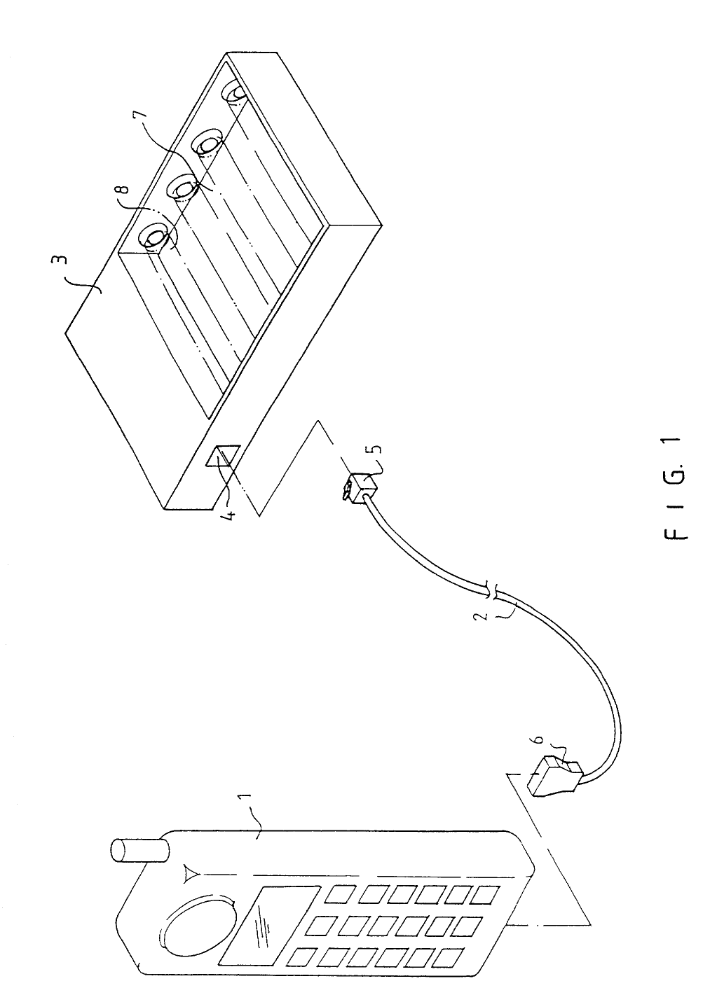

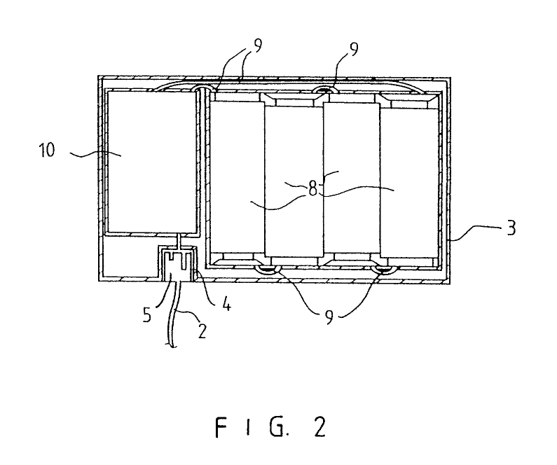

Referring to FIGS. 1 and 2, a portable telephone charger is connected to a portable telephone 1.

The portable telephone charger comprises a charging seat 3, a connection wire 2, a first plug 5, and a second plug 6.

A transformer 10 is disposed in the charging seat 3.

A cell chamber 7 is formed on the charging seat 3.

A connection socket 4 is formed on the charging seat 3 to face the transformer 10.

A plurality of inner wires 9 are disposed in the charging seat 3 to connect the transformer 10 and the cell chamber 7.

The first plug 5 is inserted in the connection socket 4.

The connection wire 2 is connected to the first plug 5 and the second plug 6.

The second plug 6 is inserted in the portable telephone 1.

The cell chamber 7 receives a plurality of normal cells 8 or various types of cells.

The invention is not limited to the above embodiment but various modification thereof may be made. Further, various changes in form and detail may be made without departing from the scope of the invention.

I claim:

1. A portable telephone charger connected to a portable telephone, the portable telephone charger comprising:
a charging seat, a connection wire, a first plug, and a second plug,
a transformer disposed in the charging seat,
a cell chamber formed on the charging seat,
a connection socket formed on the charging seat,
a plurality of inner wires disposed in the charging seat to connect the transformer and the cell chamber,
the first plug inserted in the connection socket, and
the connection wire connected to the first plug and the second plug.

2. The portable telephone charger as claimed in claim 1, wherein the cell chamber receives a plurality of cells.

3. The portable telephone charger as claimed in claim 1, wherein the connection socket faces the transformer.
